(19) United States
(12) Patent Application Publication
(10) Pub. No.: US 2017/0076328 A1
(43) Pub. Date: Mar. 16, 2017

(54) MAP PERSONALIZATION BASED ON SOCIAL CUES

(71) Applicant: GOOGLE INC., Mountain View, CA (US)

(72) Inventor: Issei Suzuki, Tokyo (JP)

(21) Appl. No.: 15/124,631

(22) PCT Filed: Mar. 3, 2015
(86) PCT No.: PCT/US15/18457

§ 371 Date: Sep. 8, 2016

Related U.S. Application Data
(60) Provisional application No. 61/947,781, filed on Mar. 4, 2014.

(51) Int. Cl. G06Q 30/02; G01C 21/36

(52) U.S. Cl. CPC G06Q 30/0261; G01C 21/367; G01C 21/3697

(57) ABSTRACT

To generate a customized digital map, signals indicative of activities of a first user at a first geographic location and a second user at a second geographic location are received. A digital map of a geographic area that includes the first geographic location and the second geographic location is generated. Detail levels at which geographic features are displayed for portions of the digital map corresponding to the first geographic location and the second geographic location are increased relative to other portions of the digital map. The digital map is then displayed at a client device operated by the first user.

### CROSS-REFERENCE TO RELATED APPLICATIONS

This application claims the benefit of U.S. Provisional Application No. 61/947,781, filed Mar. 4, 2014, the entirety of which is incorporated by reference herein.

### FIELD OF TECHNOLOGY

This application generally relates to generating digital maps and, more particularly, to automatically personalizing map information for a user based in part on the activity of other users.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Many mobile devices such as smart phones, tablet computers, and notebook computers incorporate global positioning system (GPS) and other hardware and software for determining the geographic location of the computing device and generating or displaying digital maps. Digital maps begin with a set of raw data corresponding to millions of streets and intersections, and they may include additional information regarding geographic locations within the map area (e.g., buildings, points of interest, transportation stops or stations, shops, restaurants, parks, venues, etc.). Digital maps also frequently use information from the mobile device to represent the geographic location of the mobile device on the map. Using mapping data stored locally or received from a network server, a mapping module on the mobile device may render a digital map of a certain geographic area. This map data may further include suggestions, recommendations, offers, coupons, or advertisements for businesses or other points of interest.

### SUMMARY

Generally speaking, a system implemented in a network server and/or a client device customizes a digital map for a user in view of the user's activity as well as another user's activity, when the activities of the users can be correlated. The system thus accounts for social and/or collaborative signals in addition to signals specific to the user. The customization can include elevating the detail level on the digital map for the portions corresponding to the users' current locations, generating commercial content (such as advertisements) in view of both users' profiles, etc. The system can detect potentially correlated activities for users based on calendar appointments, electronic messages, or explicit user commands. To activate this type of customization, these users in some implementations operate certain controls and/or install certain software applications.

One embodiment of these techniques is a method for generating customized digital maps executed on or more computing devices. The method includes receiving a first signal indicative of a first user's activity at a first geographic location and receiving a second signal indicative of a second user's activity at a second geographic location. The method further includes generating a digital map of a geographic area that includes the first geographic location and the second geographic location, including automatically increasing detail levels at which geographic features are displayed for portions of the digital map corresponding to the first geographic location and the second geographic location, relative to other portions of the digital map. Still further, the method includes causing the digital map to be displayed at a client device operated by the first user.

Another embodiment is a system for generating customized digital maps for display on user devices. The system includes a communication interface and processing hardware coupled to the communication interface. The processing hardware is configured to (i) receive a first signal indicative of a first user's activity at a first geographic location, (ii) receive a second signal indicative of a second user's activity at a second geographic location, (iii) generate a digital map of a geographic area that includes the first geographic location and the second geographic location, where one or more detail levels at which geographic features are selected for one or more portions of the digital map corresponding to the first geographic location and the second geographic location are automatically increased relative to other portions of the digital map, and (iv) cause the digital map to be displayed at a client device operated by the first user.

### BRIEF DESCRIPTION OF THE DRAWINGS

FIG. 1 illustrates a block diagram of an example system in which map personalization in view of social signals can be implemented;

FIG. 2 illustrates an example digital map generated in accordance with the described embodiments, displaying two areas of increased detail levels relating to a first user and a second user;

FIG. 3 is a diagram detail levels of map tiles that make up the digital map of FIG. 2; and

FIG. 4 is a flow diagram of an example method for customizing a digital map in view of signals related to two or more users; and

FIG. 5 is a flow diagram of an example method for customizing a digital map by providing additional content at locations corresponding to user locations.

### DETAILED DESCRIPTION

### General Overview

According to the techniques of this disclosure, a digital map is automatically customized in view of social and/or collaborative signals, such as past and/or current activity of multiple users. Customization can include displaying additional map features, labels, points of interest (POI), etc. at certain areas, as well as providing commercial content in view of signals related to multiple users.

In an example scenario, the user is viewing, at around lunch time, a digital map of a relatively large area in which the region around her current location as well as the region around the current location of her husband are automatically displayed with additional information, such as recommendations for places to eat at these two regions. The regions around the user's current location and the region around her husband's current location define areas of expanded detail. Each area of expanded detail can be defined by a center point corresponding to the location of a user or another party and a certain radius, which can be automatically selected in view of the zoom level. The additional information also can include indications of smaller streets, minor buildings, public transport, minor points of interests (POs), etc. The recommendations to eat can be selected based on the preferences of the user as well as the preferences of her husband. To enable these functions, the user and her husband may operate certain controls and/or install certain software. More particularly, unless the user provides permission for another to see his or her location, the user's location, additional map details, commercial content, etc. are not shared with the other user.

Moreover, the recommendations and/or other commercial content sometimes can be outside the areas of expanded detail. However, these recommendations or commercial content can be selected in view of the current locations of the corresponding people.

In another scenario, a user and his close friend are exchanging email messages or instant messages about meeting up for lunch using a service that also provides social network and digital mapping functionality. When the user then uses the service to view a digital map (on a portable device or a stationary computer using a browser, for example), additional information is provided on the map around the locations that may be relevant to both users, to help the user make a more informed decision.

In some implementations, a network server customizes map tiles, which may be provided in a vector graphics format, in view of various signals related to multiple users. For example, the tiles corresponding to locations where the user's friends are located can be generated with additional information.

### System Overview

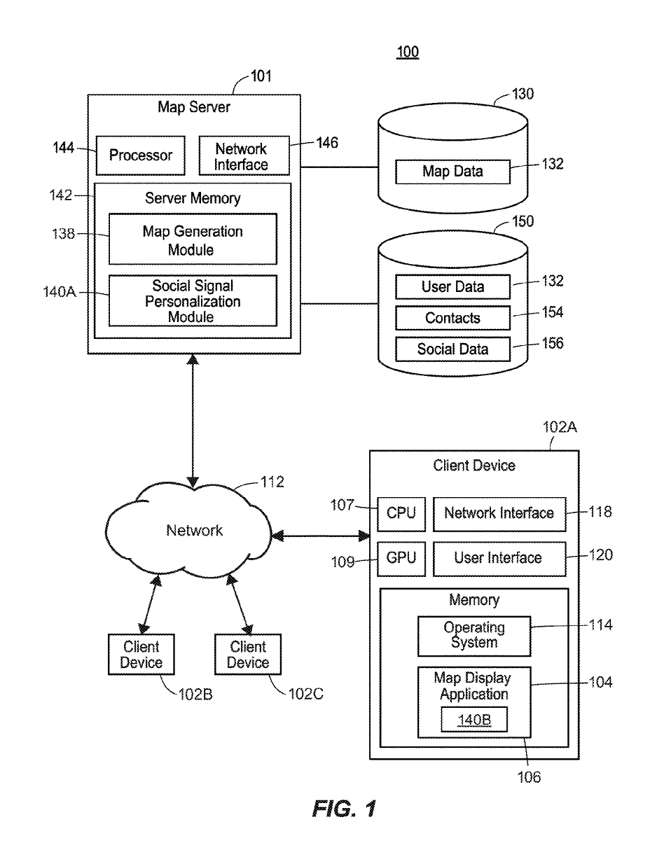

FIG. 1 illustrates a block diagram of a communication system 100 in which some or all of the map customization techniques of this disclosure can be implemented. The system 100 includes client devices 102A-C, each of which may display maps or other geographically related information using a respective instance of a map display application 104 or a similar software module. The example map display application 104 is stored in a memory 106 as a set of executable instructions that, when executed by a CPU 107 and/or a GPU 109 (shown only for client device 102A) cause maps, navigation directions, commercial content related to geography, and/or other information to be presented to the user using a user interface 120, which may include a display, a touchscreen, a speaker, etc. The map display application 104 in general can display digital map content supplied by a map server 101 via a network 112, which can be a wired or wireless, local- or wide-area network (e.g., the Internet).

In an example implementation, the map display application 104 is a special-purpose application available at an online application store disposed at the map server 101 or an application server (not shown). The user of the client device 102 may retrieve a copy of the map display application 104 from the application server and install the retrieved copy of the mapping application on the client device 102. In other embodiments, a digital mapping module that implements the relevant functions of the map display application 104 is a software component, such as a plug-in, that operates in a web browser (e.g., Google Chrome® or Apple's Safari®) or software another application.

In general, the client device 102 may be any suitable portable or non-portable computing device. By way of example, the client device 102 may be a smartphone, a tablet computer, a laptop computer, a wearable computing device, etc. In some embodiments, the client device 102 may include additional components not shown in FIG. 1 or, conversely, include fewer components than illustrated in FIG. 1. For example, the client device 102 may include multiple instances of the CPU 107 (or other suitable processors), or the client device 102 may lack the GPU 109. In some embodiments, the client device 102 may be a thin client device, such that the bulk of the computing operations are performed by the map server 101 or another server (not shown) and transmitted to the client device 102 through the network 112.

The memory 106 is a non-transitory memory and can include such components as a random access memory (RAM), a read-only memory (ROM), a hard disk drive, a flash memory, or any other type of memory. In addition to the map display application 104, the memory 106 may store an operating system (OS) 114 and one or more local applications or modules (not shown). The operating system 114 may be any type of suitable operating system. The map display application 104 may receive digital map content through a network interface 118, which may communicate with the map server 101 through the network 112.

The map server 101 may be communicatively coupled to multiple databases, such as a map database 130 and a user database 150. Depending on the implementation, the databases 130 and 150 can be associated with a same online service or different services operated by independent providers. These databases can be implemented in any suitable manner, such as sets of tables forming a relational database, on one or multiple physical storage devices.

The map database 130 may store map data 132, including street and road information, topographic data, satellite imagery, building or structure information, information related to public transport routes, information about businesses or other points of interest, information about current traffic conditions, etc. Individual components that make up an interactive digital map can be referred to as “map features.” In general, each map feature represents a real-world physical entity. In addition to map features, the map data 132 can include text labels, point-of-interest (POI) descriptions, metadata indicating how and when some of the map features are displayed, etc.

In one example implementation, the geometry of each map feature is defined in a vector graphics format or another scaleable format. In addition to the geometry of a map feature, the map database 130 can store descriptions of visual attributes such as stroke width, color, etc., which may be referred to below as “style data.” When rendering a map feature, the client device 120A-C can apply the appropriate style data to map feature geometry. Style data can be specific to a zoom level, map type (e.g., traffic, transit), etc. Additionally or alternatively, some of the map data 132 can be stored in a raster (i.e., bitmap) format.

The map data 132 also can specify detail levels associated with various map features. For example, the map data 132 can indicate zoom levels at which information regarding buildings or roads should be presented as part of a digital map. As a more specific example, local roads can be visible at zoom levels Z_{N}-Z_{M}, buildings can be visible at zoom levels Z_{M}-Z_{K}, highways can be visible at zoom levels Z_{N}-Z_{K}, etc. Thus, when certain map features are “promoted” across zoom levels in a certain portion of the digital map, the map features are displayed at zoom levels at which these features are normally not visible.

When the map server 101 transmits portions of the map data 132 for a certain geographic region, the map server 101 can partition the map data into region map data can be organized into map tiles, or shapes of a predefined size. In one example implementation, map tiles are squares defined at a certain size for each zoom level, where a map tile at zoom level Z_{N} is made up of four map tiles at zoom level Z_{N+1}, each map tile at zoom level Z_{N+1} is made up of four map tiles at zoom level Z_{N+2}, etc.

With continued reference to FIG. 1, the user database 150 may store user data 152, contacts 154, social data 156, and other information relating to a user. The user data 152 may include information related to the user's preferences, frequently visited locations, typical transportation modes and routes, searches, purchases, ratings or review of businesses or products, calendar appointments, reminders for tasks, or other information related to the user. The social contacts 154 may include information regarding other individuals whom the user has identified or with whom the user has recently interacted, as well as information regarding the type of social relationship between the user and the other individuals (e.g., professional, social, familiar, friendly, etc.). For example, the social contacts 154 may include a list of individuals with whom the user has connected via a social media platform and the types of connections. The social data 156 may include information regarding interactions between the user and other individuals, such as e-mail exchanges, telephone calls, text message exchanges, joint calendar appointments or scheduled meetings, or other information regarding interactions or predicted interactions between the user and other individuals. To enable these functions, the user and the other individuals may operate certain controls or install certain software on the client devices 102 or other computing devices.

Although shown as being stored in two databases 130 and 150, it should be understood that the information contained therein may be disposed within one or any number of databases in any number of physical locations. For example, vector and raster graphics in the map data 132 may be stored in two separate databases, communicatively coupled to the map server 101, and at least some of the contacts data 154, or social data 156 may be stored in other databases, communicatively coupled to the map server 101.

In some embodiments, the map server 101 may include a map generation module 138 and a social signal personalization module 140A stored in a server memory 142 and executed by a processor 144. Although the map server 101 is illustrated as a single device, it should be understood that the map server 101 may include any number of communicatively connected servers, any number of which may be used for processing various types of content.

In operation, the map server 101 may respond to geographic queries initiated at the client device 102 by executing the map generation module 138. For example, a user of the client device 102 may request a map of a geographic area (e.g., the area surrounding the location of the client device 102) or may request a map showing businesses of a specified type (e.g., restaurants, bicycle shops, etc.) in a geographic area. In some embodiments, the request may be initiated by a user interacting with the map display application 104 or the user interface 120. In an embodiment, the map server 101 may provide a digital map to the user through the client device 102 based upon information regarding the user's location, preferences, or recent activity or information regarding social contacts of the user. Subsequently, the client device 102 may send a request for related map data to the map server 101. Upon receiving a request for map data via the network 112, the map server 101 may request or retrieve data from the map database 130 and the user database 150.

The personalization module 140A of the map server 101 may determine the geographic locations of client devices 102A-C and receive other signals indicative of the corresponding users' activities (to which end these users operate certain controls and install certain applications, in an embodiment). In some implementations, the personalization module 140A may pass personalization information to the map generation module 138, and the map generation module may use such information in generating vector or raster map tile data, as described in further detail below. For example, the personalization module 140A may determine the location of multiple client devices 102, and the map generation module 138 may then provide more detailed map information around those locations. As a more specific example, the map generation module 138 can increase the detail level for one or several map tiles corresponding to the users' locations without increasing the detail level for the other tiles. The map generation module 138 can also generate additional commercial content based on signals related to multiple users. The map server 101 may then send the map tile data to the client device 102 through the network 112, where the map display application 104 may generate a digital map using the map tile data. The client device 102 may then present the digital map to the user via the user interface 120.

Additionally or alternatively, a personalization module 140B can be implemented in one or several of the client devices 102A-C. The personalization module 140B implemented in the client device 102A modifies the map data received from the map server 101 in view of signals related to the user of the client device 102A as well as signals related to one or more other users. Similar to the personalization module 140A discussed above, the personalization module 140B can select additional map features for display at relevant locations, “promote” map features across zoom levels, display additional labels and POI indicators, provide commercial content in view of user and/or social data related to multiple users, etc. If desired, the map server 101 in these embodiments can send the same map data to multiple client devices for subsequent customization by the personalization module 140B. In other embodiments, customization can be distributed between the personalization modules 140A and 140B, i.e., between the map server 101 and the client device 102A.

### Example Digital Map Customized in View of Signals Related to Multiple Users

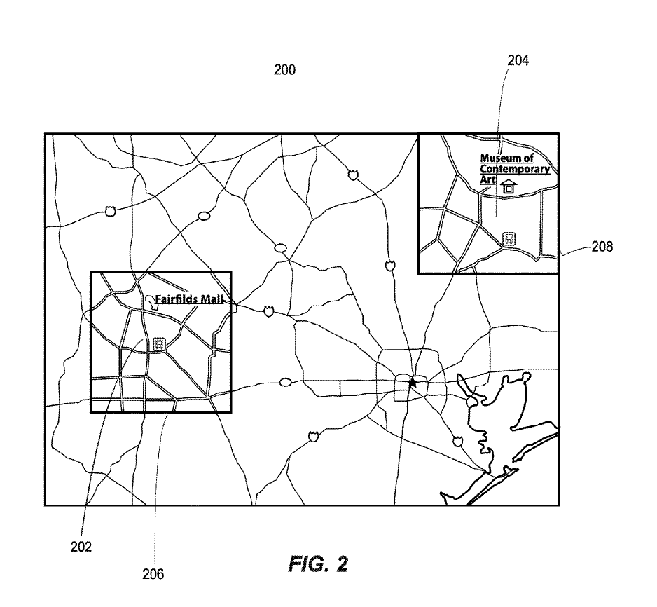

FIG. 2 illustrates an exemplary digital map 200 that may be generated by the system 100 as described above and displayed to the user of the client device 102A using the user interface 120. The digital map 200 includes a first client device location 202 and a second client device location 204, indicating the locations of the user and a social contact of the user (i.e., another user), respectively. As depicted in FIG. 2, the areas 206 and 208 surrounding the locations 202 and 204, respectively, are presented with higher detail levels than the remainder of the digital map 200. Among other advantages, this may allow the user to identify side streets for parking, bus stops, locations to meet the social contact, or more efficient routes around buildings and other obstructions. For example, the user may be at the first client device location 202, and her husband may be in a nearby area at the second client device location 204. Based on the increased detail level of area 208 and other factors (e.g., time of day, the user's recent interactions with the social contact, the social contact's recent activity or schedule, etc.), the user may receive information regarding local restaurants. This may assist the user in selecting a location to meet with the social contact. Moreover, the digital map 200 can include commercial content selected in view of the profiles of both users. As noted above, the user and other individuals may operate certain controls or install certain software on the client devices 102 or other computing devices to enable this functionality.

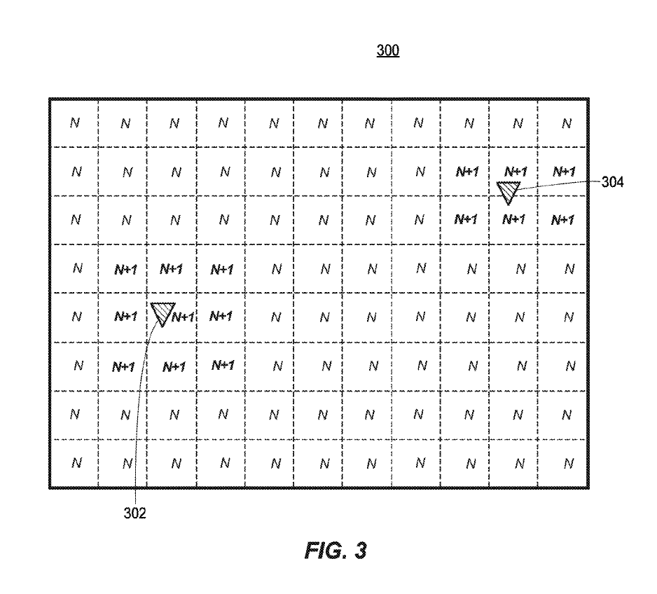

FIG. 3 illustrates a diagram 300 of the exemplary digital map 200, displaying detail levels of individual map tiles. Digital maps are frequently composed of a number of map tiles, with each tile containing information regarding a portion of the map. Additionally, digital maps frequently utilize a number of detail levels (e.g., zoom levels) to present a useful level of information relative to the layout of the map, as viewed by a user. For example, building-level detail may be relevant to a use when the entire map area displays several blocks, but displaying such detail would be untenable or distracting when the map area displays an entire city. As another example, roadways may be displayed on a map based on the detail level, such that only major thoroughfares are presented at low detail levels, whereas side streets and alleys may be presented on a map only at high detail levels. In addition, detail level may be used to determine various additional information to present to a user, such as points of interest (e.g., parks, shops, museums, government buildings, etc.), recommendations (e.g., based on location, recent searches, e-mail or message content, past locations visited by the same group of users, etc.), suggestions (e.g., businesses, parking, train stations, etc.), search results, coupons, advertisements, or other useful information associated with a geographic point within the map. As noted above, the user and other individuals may operate certain controls or install certain software on the client devices 102 or other computing devices to enable this functionality.

Similar to FIG. 2, the diagram in FIG. 3 illustrates that the map tiles near the client device locations 302 and 304 are presented at a higher detail level (level N+1) than the map baseline (level N). Although one region of a uniform detail level is depicted around each client device location 302 and 304 in FIG. 3, it should be understood that additional areas of different detail levels may be used. For example, a gradient may be applied to tiles such that the detail level is inversely related to the distance from each client device location (e.g., ranging from N+3 to N as the distance from the nearest client device location increases).

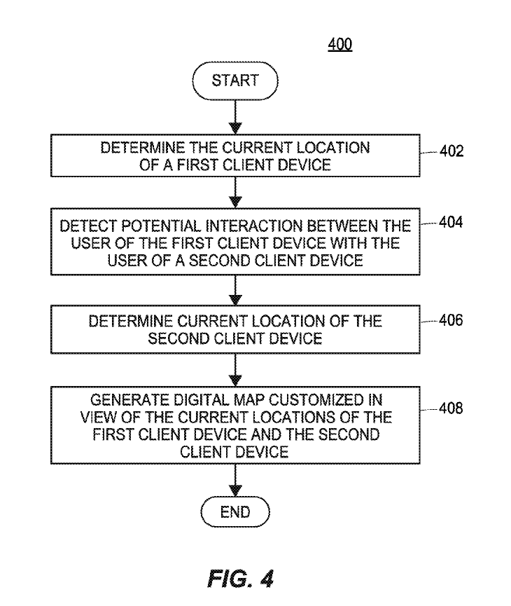

FIG. 4 is a flow diagram of an example method 400 for customizing a digital map in view of signals related to two or more users that may be implemented in the personalization module 140A and/or personalization module 140B, depending on the implementation. The method 400 can be implemented as a set of instructions stored on a non-transitory computer-readable medium and executed by one or more processors.

Upon initiation of the process 400, the location of a first client device 102, operated by a first user, is determined at block 402. This may include requesting information regarding the location of the first client device 102, such as Global Positioning System (GPS) or other satellite positioning information, terrestrial positioning information (e.g., cellular data network towers, etc.), or other known means (e.g., proximity to Wi-Fi hotspots, etc.). In some embodiments, the determination of the location of the first client device 102 may include receiving location information, such as where the method 400 is initiated by the first client device 102.

At block 404, a potential interaction between the user for whom the digital map is being generated and another user is detected. This potential interaction can be determined based on user commands, electronic messages, calendar appointments, etc. The other user may be selected from the contacts 154 associated with the user of the first client device 102, for example.

The location of the corresponding client device is determined at block 406. In this implementation, the location of the second user is associated with the location of the second user's portable device such as a smartphone. In general, however, customization can be based on any other indication of the location of the second user.

At block 408, a digital map is generated for display at the first client device operated by the first user, with the map data customized in view of the current location of the first user as well as the second user. As indicated above, customization can include increasing the detail level for portions of the digital map corresponding to locations of the first client device and the second client device (likely corresponding to the locations of the first user and the second user, respectively). In some implementations, the digital map generated at block 408 can include detail level information regarding map tiles at one or more zoom levels. The detail level information may be included in raster or vector data related to map tiles, and may further include information regarding terrain, roadways, tracks, trails, watercourses, buildings, and other physical location information relating to the geographic area of the map. Additionally, the detail level information may include information regarding events, businesses, entities, activities, or other information regarding the geographic locations within the map area (e.g., points of interest, transportation stops or stations, shops, restaurants, venues, performance times, recommendations, ratings, menus, etc.).

The selection of information to be included at each detail level may be determined by means of weighting the various information based on the user data 152, social contacts 154, social information 156, and other extrinsic information (e.g., time of day, weather, calendar appointments, e-mail or other messages, etc.), which may require the user or other individuals to operate certain controls or install certain software on the client devices 102 or other computing devices. Such weighting may be performed using a variety of known learning or optimization algorithms, some portion of which may also be manually adjusted or specified. The information generated in block 408 may then be displayed to the user via the user interface 120.

In some embodiments, the digital map may be generated on the map server 101 and displayed on a client device 102, so the map server 101 may transmit the map information discussed above to the client device 102 for display. The client device 102 may construct and display the digital map using one or more of the map display application 104, the CPU 107, the CPU 109, or the user interface 120. For example, vector data for a several map tiles and additional detail level information may be generated at the server 101 by the map generation module 138 in connection with the personalization module 140, then transmitted via the network 112 to the client device 102, where it may be processed by the map display application 104 executed by the CPU 107 and displayed on the user interface 120 using the GPU 109.

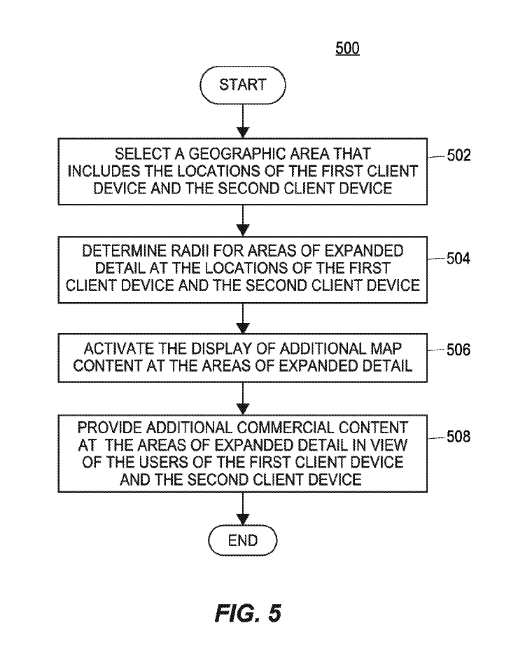

FIG. 5 is a flow diagram of another example method for customizing a digital map by providing additional content at locations corresponding to user locations, which also can be implemented in the personalization module 140A and/or 140B. Similar to the method 400, the method 500 can be implemented as a set of instructions stored on a non-transitory computer-readable medium and executed by one or more processors.

The method 500 may begin by selecting a geographic area that includes the geographic locations of the first client device and the second client device operated by the first user and the second user, respectively. The zoom level for the digital map can be selected depending on the distance between the two locations, so as to include both locations.

At block 502, radii for areas of expanded detail are determined for the first geographic location and the second geographic location. For example, at a certain zoom level, the radius can correspond to several city blocks. At a lower zoom level, the radius can correspond to several miles. Accordingly, each area of expanded detail can approximately correspond to a circle centered at the corresponding geographic location and having the radius determined at block 502. In a map tile implementation, map tiles at least partially covered by the corresponding circle can be selected (see FIG. 3).

Once the areas of expanded detail have been selected, additional map content and/or additional commercial content can be selected at blocks 506 and/or 508. It is noted that the method 500 in different embodiments can include one or both of the blocks 506 and 508.

At block 506, additional map content such as map features, labels, POI indicators, etc. is selected for an area of expanded detail. For example, the digital map can illustrate smaller, more minor buildings, and subway stations with an area of expanded detail. Further, additional labels can provide further guidance to the user within these areas.

At block 508, additional commercial content is generated for the areas of expanded detail. Such content can include automatic suggestions, recommendations, offers, coupons, or advertisements, etc. These suggestions, recommendations, offers, coupons, or advertisements may be generated based upon any predicted shared activities and interactions determined as discussed above, and can be based on the profiles of both users.

In some implementations, map content and/or commercial content determined based on signals related to both users can be provided outside the areas of expanded detail. For example, the personalization module 140A can determine that both users often visits movie theaters, and in response highlight locations of movie theaters that may be outside every area of expanded detail, but still on the digital map that includes these areas.

Referring generally to blocks 506 and 508, generating map content and/or commercial content may include separately weighing the likelihood a user will find information regarding locations (e.g., stations, shops, etc.) or activities (e.g., transportation, dining, etc.) to be useful, based upon the user data 152 or social data 156 using the personalization module 140. For example, a suggestion of a bus stop near the client device may be generated and added to the map information based on user data indicating that the user frequently takes a particular bus route at a similar time of day. The locations of additional client devices may also be included, however, and their inclusion may change the suggestion or recommendation. For example, the personalization module 140A can generate a suggestion of nearby taxies or a recommendation of a taxi service, rather than bus stop information, if the personalization module 140A determines that multiple social contacts are near the user. This determination can be based further on the user's prior activity or preferences. Thus, social information regarding the locations of other users may be used to influence the additional information selected at blocks 506 and 508. To enable these functions, the user and other individuals may operate certain controls or install certain software on the client devices 102 or other computing devices.

As above, the selection of additional information regarding suggestions, recommendations, offers, coupons, or advertisements to include in the map data may be determined by means of weighting the various information based on the user data 152, social contacts 154, social data 156, and other extrinsic information. The map server 101 may then transmit the map tile data (including the additional data generated at blocks 506 and 608) to the client device 102 via the network 112. The digital map may then be presented to the user. Some or all of the foregoing actions may be repeated to update the map based upon user interaction with the map, a change in the location of one or more of the client devices 102, or other changes affecting the map information (e.g., map tile version updates, the arrival of additional client devices 102 within the map area, or the passage of time).

### Additional Considerations

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain embodiments are described herein as including logic or a number of components, modules, or mechanisms. Modules may constitute either software modules (e.g., code stored on a machine-readable medium) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

A hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module in dedicated and permanently configured circuitry or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules can provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and buses) that connect the hardware or software modules. In embodiments in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as an SaaS. For example, as indicated above, at least some of the operations may be performed by a group of computers (as examples of machines including processors), these operations being accessible via a network (e.g., the Internet) and via one or more appropriate interfaces (e.g., APIs).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art.

Upon reading this disclosure, those of skill in the art will appreciate still additional alternative structural and functional designs for customizing a digital map in view of social signals through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims. Accordingly, the appearances of the phrase “in one embodiment” in various places in the specification are not necessarily all referring to the same embodiment.

What is claimed is:

1. A method for generating customized digital maps, the method comprising:
receiving, by one or more computing devices, a first signal indicative of a first user's activity at a first geographic location;
receiving, by the one or more computing devices, a second signal indicative of a second user's activity at a second geographic location;
generating, by the one or more computing devices, a digital map of a geographic area that includes the first geographic location and the second geographic location, including automatically increasing detail levels at which geographic features are displayed for portions of the digital map corresponding to the first geographic location and the second geographic location, relative to other portions of the digital map; and
causing, by the one or more computing devices, the digital map to be displayed at a client device operated by the first user.

2. The method of claim 1, further comprising determining, by the one or more processors, potential interaction between the first user and the second user based on the first signal and the second signal, at a location within the geographic area.

3. The method of claim 1, wherein automatically increasing the detail levels comprises promoting, by the one or more computing devices, a plurality of geographic features across zoom levels to display map elements corresponding to the plurality of geographic features at lower levels of magnification.

4. The method of claim 1, further comprising:
generating, by the one or more computing devices, commercial content including one or more of (i) a recommendation, (ii) an offer, (iii) a coupon, or (iv) an advertisement, associated with a location within the geographic area, based on the first signal and the second signal; and
providing the commercial content on the digital map.

5. The method of claim 4, wherein generating the commercial content includes selecting the commercial content in view of first preferences of the first user and second preferences of the second user.

6. The method of claim 1 implemented by one or more networked servers, wherein generating the digital map comprises:
generating map data for rendering a digital map image at the client device, and providing the map data to the client device via a communication network.

7. The method of claim 6, wherein providing the map data to the client device further comprises providing a plurality of map tiles to the client device, each of the map tiles including vector graphics data for a region of the map of a fixed size.

8. The method of claim 1, wherein the client device is a first client device; the method further comprising causing, by the one or more computing devices, the digital map to be displayed at a second client device operated by the second user.

9. A system for generating customized digital maps for display on user devices, the system comprising:
a communication interface; and
processing hardware coupled to the communication interface and configured to:
receive a first signal indicative of a first user's activity at a first geographic location;
receive a second signal indicative of a second user's activity at a second geographic location;
generate a digital map of a geographic area that includes the first geographic location and the second geographic location, wherein one or more detail levels at which geographic features are selected for one or more portions of the digital map corresponding to the first geographic location and the second geographic location are automatically increased relative to other portions of the digital map; and
cause the digital map to be displayed at a client device operated by the first user.

10. The system of claim 9, wherein the processing hardware is further configured to determine potential interaction between the first user and the second user based on the first signal and the second signal, at a location within the geographic area.

11. The computing device of claim 9, wherein to automatically increase the detail levels, the processing hardware is configured to promote a plurality of geographic features across zoom levels to display map elements corresponding to the plurality of geographic features at lower levels of magnification.

12. The computing device of claim 9, wherein the processing hardware is further configured to:
generate commercial content including one or more of (i) a recommendation, (ii) an offer, (iii) a coupon, or (iv) an advertisement, associated with a location within the geographic area, based on the first signal and the second signal, and providing the commercial content on the digital map.

13. The computing device of claim 12, wherein to generate the commercial content, the processing hardware is further configured to select the commercial content in view of first preferences of the first user and second preferences of the second user.

14. The computing device of claim 9, wherein to cause the digital map to be displayed to the first user, the processing hardware is configured to transmit a plurality of map tiles to the client device, each of the map tiles including vector graphics data for a region of the map of a fixed size.

15. The computing device of claim 9, wherein the client device is a first client device; the processing hardware further configured to cause the digital map to be displayed at a second client device operated by the second user.

16. A system for generating customized digital maps for display on user devices, the system comprising:
a communication interface; and
processing hardware coupled to the communication interface and configured to:
receive an indication of a first geographic location at which a first user operates a first client device;
receive an indication of a second geographic location at which a second user operates a second client device;
generate a digital map of a geographic area that includes the first geographic location and the second geographic location;
generate geolocated commercial content related to the geographic area, based on the first user's profile and the second user's profile, for display on the digital map;
provide the digital map and the geolocated commercial content to the first client device and the second client device.

17. The system of claim 16, wherein the processing hardware is configured to increase levels of detail for portions of the digital map corresponding to the first geographic location and the second geographic location.

18. The system of claim 17, wherein each of the portions is defined by a center point corresponding to the first geographic location and the second geographic location, respectively, and a predefined radius.

19. The system of claim 16, wherein the processing hardware is further configured to receive a signal indicative of a potential interaction between the first user and the second user at a location within the geographic area,
wherein the processing hardware generates the digital map in response to the signal.

20. The system of claim 16, wherein the processing hardware is configured to select the commercial content in view of first preferences of the first user and second preferences of the second user.
